(19) United States
(12) Patent Application Publication
(10) Pub. No.: US 2013/0194818 A1
(43) Pub. Date: Aug. 1, 2013

(54) VENTILATING ELEMENT OF A CASING OF A LIGHTING OR SIGNALLING DEVICE OF A VEHICLE

(71) Applicants: Manuel Gomez, Martos (ES); Juan-Antonio Rubia, Martos (ES)

(72) Inventors: Manuel Gomez, Martos (ES); Juan-Antonio Rubia, Martos (ES)

(73) Assignee: Valeo Vision, Bobigny Cedex (FR)

(21) Appl. No.: 13/749,818

(22) Filed: Jan. 25, 2013

(30) Foreign Application Priority Data
Jan. 27, 2012 (FR) 1250808

(51) Int. Cl. F21S 8/10

(52) U.S. Cl. CPC F21S 48/321
USPC 362/547

(57) ABSTRACT

A ventilating element of a casing of a lighting or signaling device of a vehicle. The ventilating element comprises essentially a cover with a cavity enclosing a filtering membrane, a mounting surface on a wall of the casing and an end-piece for connecting to an air duct. The filtering membrane is placed on a seat formed in the cavity of the cover, approximately level with the mounting surface. An openwork wall is placed against the filtering membrane on a face of the membrane that is on the other side from the seat in the cavity. The ventilating element is mounted on a wall provided with a dedicated opening so that the peripheral edge of the openwork wall comes into contact with the wall, thus keeping the said openwork wall and the filter in place.

### CROSS-REFERENCE TO RELATED APPLICATIONS

This application claims priority to French Application No. 1250808 filed Jan. 27, 2012, which application is incorporated herein by reference and made a part hereof.

### BACKGROUND OF THE INVENTION

1. Field of the Invention

The invention relates to a ventilating element of a casing, notably a casing of a lighting and/or signaling device of a vehicle. The invention also relates to a casing wall fitted with a ventilating element. The casing may notably be a casing of a lighting and/or signaling device of a vehicle. The invention also relates to a casing comprising the said wall and/or the said ventilating element. More particularly, the casing is of a lighting and/or signaling device of a vehicle. The invention also relates to a lighting and/or signaling device of a vehicle fitted with the said wall and/or with the said ventilating element.

2. Description of the Related Art

Patent document EP 0 764 811 A1, which is equivalent to U.S. Pat. No. 5,758,957, discloses a lighting or signaling device of a vehicle fitted with a ventilating element comprising essentially first arrangements on a wall of the casing of the lighting or signaling device and second arrangements formed on a plug mounted on the wall. The wall of the casing comprises a reinforcement designed to form a sinuous passage for the ventilation air with the plug. This sinuous passage is designed to prevent any entrance of water into the casing notably during the washing of the engine compartment by means of a high-pressure washing jet. The wall also comprises an opening separated from the reinforcement by a low wall and designed to allow the passage of ventilation air. The plug has the shape of a cap designed to cover the reinforcement and the opening. It comprises lower lateral openings for the inlet of air, a low internal wall designed to penetrate the reinforcement of the wall and to form a route that is sinuous and generally directed upwards for the ventilation air. It also comprises two elongate teeth designed for coupling with the opening of the wall. These teeth interact elastically via positive contact surfaces with the opening of the wall so as to ensure a stable attachment of the plug to the wall. The ventilation air penetrates the cavity of the plug through the lower lateral openings. It then describes a sinuous route along the low internal wall of the plug, along the reinforcement of the wall and again along the low internal wall of the plug and of the low wall of the wall separating the reinforcement from the opening. The air then penetrates the space between the coupling teeth so as to then travel across the opening of the wall. A foam filter may be placed upstream of the opening of the wall, in an upper cavity of the plug. This device certainly makes it possible to prevent water entering the volume of the casing of the lighting or signaling device. However, it has the drawback of generating considerable pressure losses, notably because of the sinuous route for the ventilation air. It is therefore not suitable for ensuring a cooling function for the casing or for one or more elements placed in the casing. Moreover, it requires constraining arrangements at the wall of the casing which makes the production of the casing more complex and hence more costly.

Patent document FR 2 660 412 A1 discloses a lighting or signaling device for a vehicle, the device being ventilated via a communication system with chicane and with a hydrophobic filter. The system comprises a ventilation channel at a front wall of the casing of the lighting or signaling device. A hydrophobic filter is placed inside the ventilation channel. The system also comprises a bent pipe connected to the ventilation channel so as to form a chicane. Although fairly simple to produce, this system has the drawback of being limited to a function of aerating or ventilating the casing and not to a cooling of the casing or more precisely of one or more elements placed in the casing. Specifically, the passage cross section is fairly reduced and the chicane is essentially designed to prevent water entry particularly when the engine compartment is cleaned with the aid of a high-pressure jet. Moreover, this system requires particular arrangements at the wall, which makes the production of the casing more complex and hence more costly.

### SUMMARY OF THE INVENTION

The object of the invention is to propose a ventilating element of a casing notably for a lighting and/or signaling device of a vehicle that alleviates at least one of the abovementioned drawbacks. More particularly, the object of the invention is to propose a ventilating element of a casing notably of a lighting and/or signaling device of a vehicle that is capable of cooling the casing or one or more elements placed in the casing. A further object of the invention is to propose a ventilating element that is simple to produce particularly in the arrangements necessary on the casing.

The subject of the invention is a ventilating element of a casing, notably of a casing of a lighting and/or signaling device of a vehicle, comprising: a cover defining an internal volume with an entrance and an exit arranged to allow the circulation of air from the entrance to the exit or vice versa; reversible means for attaching the cover to a wall of the casing, the cover comprising a seat for receiving a filter.

According to one exemplary embodiment of the invention, the wall of the casing is generally flat. The filter may be a filtering membrane in order to further improve the filtering of undesirable elements. According to one variant embodiment, the filtering membrane that is generally flat and parallel to the wall when the cover is mounted on the wall.

According to an exemplary embodiment of the invention, the cover produces a closed passage between the entrance and the exit, notably a duct between the entrance and the exit. The passage is thus sealed which improves the filtering.

According to an exemplary embodiment of the invention, the ventilating element comprises the filter, the latter being placed so that the air passes through the filter when it travels from the entrance to the exit or vice versa.

According to an exemplary embodiment of the invention, the seat of the filter is situated at the exit of the internal volume.

According to an exemplary embodiment of the invention, the filter comprises a filtering membrane and the seat forms a shoulder designed to receive the edge of the filtering membrane. The positioning of the membrane is thus simpler.

According to an exemplary embodiment of the invention, the cover comprises at least one bearing zone for the central portion of the membrane. According to one embodiment, the bearing zone extends in a direction that is generally perpendicular to the plane of the membrane. The bearing zone may comprise one or more studs extending preferably, in a non-limiting manner, in a direction that is generally perpendicular to the plane of the membrane.

According to an exemplary embodiment of the invention, the cover comprises a surface for mounting the cover on the wall, the surface encircling the seat of the filtering membrane.

According to an exemplary embodiment of the invention, the surface for mounting the cover on the wall and/or the seat of the filtering membrane are circular. This makes it easier to mount the ventilating element on the wall.

According to an exemplary embodiment of the invention, the cover comprises at least two hooks capable of engaging with the wall by a rotary movement of the cover. The mounting and removal of the ventilating element are thus carried out simply.

According to an exemplary embodiment of the invention, the ventilating element comprises removable means for keeping the filter on the seat of the cover. It is thus possible to change only the filter and to reuse the ventilating element once the filter has been changed.

According to an exemplary embodiment of the invention, the removable means for keeping the filter on the seat of the cover comprise an openwork wall, notably connected to the cover by a flexible connection. This involves a simple embodiment of these removable means for holding the filter.

According to an exemplary embodiment of the invention, the cover and the removable means for holding the filter are configured so that the removable means can be mounted on the cover by clipping. Alternatively or in addition, the removable means for holding the membrane, notably the openwork wall, may be held in place by contact with the wall when the ventilating element is mounted on the wall.

According to an exemplary embodiment of the invention, the cover comprises an end-piece at the entrance of the internal volume designed to receive an air duct. The duct, by extending the route of the air, makes it possible to further prevent solid or liquid elements from entering the cover. This duct may be flexible in order to make it easier to mount on the end-piece.

According to yet another advantageous embodiment of the invention, the cover comprises the filter. According to an embodiment of the invention, the filter is a filtering membrane having hydrophobic and/or oleophobic properties.

A further subject of the invention is a casing wall, notably of a lighting and/or signaling device of a vehicle, this wall being provided with a ventilating element according to the invention.

According to an exemplary embodiment of the invention, the wall comprises at least one opening with at least two edges, for example circular edges for easier mounting. According to one embodiment, each of these edges has a variation in diameter so as to allow the insertion of the hooks of the cover and their coupling with the edges by rotation of the ventilating element.

According to an exemplary embodiment of the invention, at least one of the circular edges has a boss in the region of the variation in diameter, the boss forming a zone of friction with one of the hooks during rotation and preventing the ventilating element from being separated by a reverse rotary movement.

A further subject of the invention is a casing of a lighting and/or signaling device of a vehicle, noteworthy in that it comprises a ventilating element according to the invention and/or a wall according to the invention.

A further subject of the invention is a lighting and/or a signaling device that is noteworthy in that it comprises a casing according to the invention.

These and other objects and advantages of the invention will be apparent from the following description, the accompanying drawings and the appended claims.

The abovementioned measures make it possible to produce a ventilating element notably for cooling that is capable of channelling a greater flow of air notably for cooling, by virtue of a filter with a greater surface area. They also allow an extremely easy mounting of the ventilating element on a wall. The verification of the state of the filter and its replacement are also made simpler. Specifically the filtering membrane is held in place by the openwork wall which itself is held in place by contact with the wall on which the ventilating element is mounted.

### BRIEF DESCRIPTION OF THE ACCOMPANYING DRAWINGS

Other particular features and advantages of the invention will be better understood with the aid of the description of the figures amongst which:

FIG. 1 is a view in section of a ventilating element of a casing of a lighting and/or signaling device of a vehicle, the ventilating element being mounted on a wall of the casing, the ventilating element and the wall being according to the invention;

FIG. 2 is an exploded view of the ventilating element of FIG. 1;

FIG. 3 is a view at another angle of the ventilating element of FIG. 2, the ventilating element being in closed configuration ready to be mounted on a casing wall;

FIG. 4 is a partial view of a casing wall from the inside of the casing, the wall being fitted with a ventilating element according to FIGS. 1 to 3; and

FIG. 5 is a view of the wall of FIG. 4 from the outside of the casing.

### DETAILED DESCRIPTION OF THE PREFERRED EMBODIMENTS

In the following description, the terms qualifying the position of certain elements, such as “upper”, “lower” etc., refer to the specific arrangements of the figures. These terms are however not to be interpreted in a strict and absolute manner but in a relative manner. Specifically, the signaling modules that are described therein may be in practice oriented differently without in any way departing from the invention.

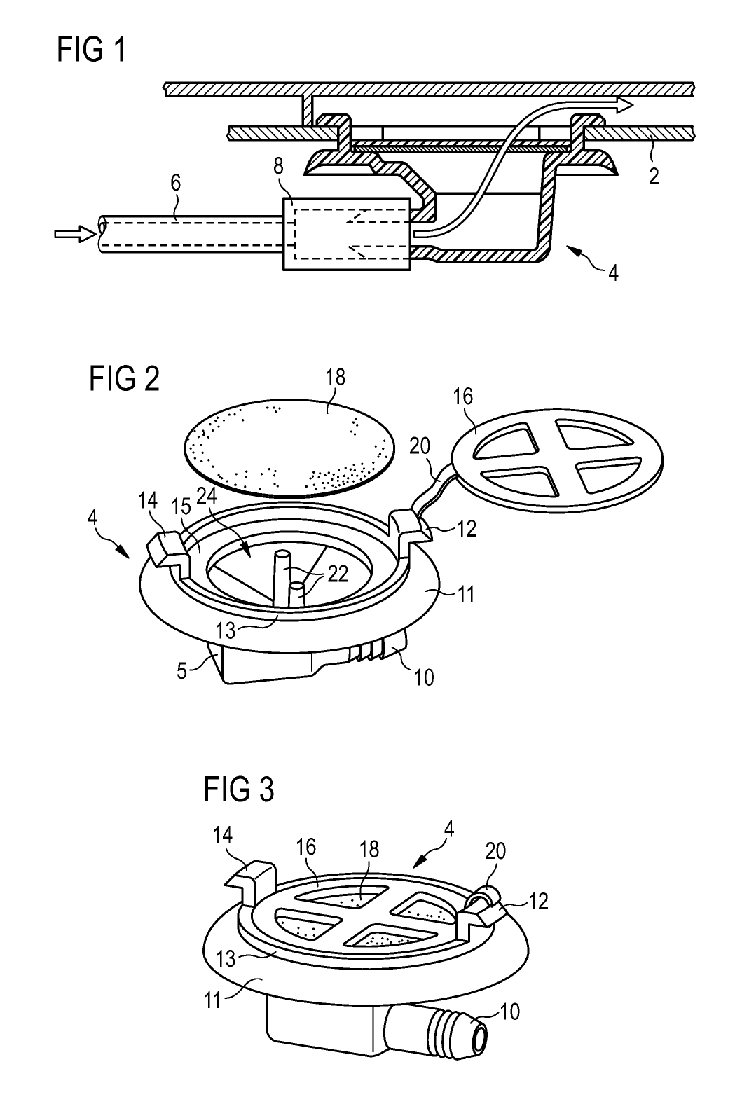

FIG. 1 is a view in section of a wall 2 of a casing (not shown) notably of a lighting or signaling device, the wall 2 being fitted with a cooling-air inlet device or else a ventilating element 4. The wall 2 is generally flat at least in the location receiving the ventilating element 4. The wall 2 is provided with an opening designed to receive the air originating from the ventilating element 4. The latter is connected in an aeraulic manner with an air inlet duct 6, and this is done via a connector 8. The air flow may be generated naturally by the speed of movement of the vehicle or it may be forced notably by a fan.

The ventilating element 4 is further illustrated in FIGS. 2 and 3. It comprises a cover 5 forming an internal volume or else a cavity 24. The cover 5 has a generally circular shape with a funnel-shaped cross section. It comprises a lower portion of generally parallelepiped shape with a connection end-piece 10. The cover 5 also comprises a generally circular upper portion with a flange-shaped mounting surface 11. The latter comprises a generally flat annular bearing surface and a surface adjacent to the bearing surface, of generally curved cross section. The mounting surface 11 may be sufficiently flexible to ensure a seal by direct contact with the wall 2, that is to say without the presence of an additional seal.

The cover 5 also comprises a cylindrical portion 13 protruding from the mounting surface 11. The upper edge of this cylindrical portion 13 is designed to come into contact with the wall 2.

The cover 5 also comprises two mounting hooks 12 and 14 protruding from the mounting surface 11 and in the extension of the cylindrical surface 13. They are designed to interact with the wall 2 of the casing for the purpose of attaching the ventilating element 4 thereto. Each of these hooks 12 and 14 has a profile in cross section (that is to say along a plane passing through the axis of revolution of the mounting surface 11 and of the cylindrical surface 13) in the form of an inverted “L” or a bracket shape.

The cover 5 also comprises, in its cavity 24, a seat 15 forming a generally annular bearing surface approximately at the height of the mounting surface 11. The seat 15 is delimited at its outer periphery by the internal surface of the cylindrical portion 13. The seat 15 is designed to receive a filtering element 18 in the form of a circular pad or membrane. The cavity 24 of the cover 5 comprises two studs 22 placed generally perpendicular to the plane of the seat 15 and level with the latter so as to form a support for the central portion of the filtering membrane 18.

The objective of the filtering membrane 18 is to filter the entering air by retaining the dust present in the air. It may also be hydrophobic, that is to say have characteristics for repelling the humidity that is present in the air. Such properties are particularly worthwhile for vehicle front headlight casings that are likely to be fed with cooling air that is potentially filled with humidity, notably because of the position of the air intake at the front of the vehicle. The filtering membrane 18 may also be oleophobic, namely have properties for repelling oils and hydrocarbons that may be present in the cooling air. Such properties are particularly worthwhile for casings of vehicle rear lights of which the cooling air intake may be situated at the rear of the vehicle.

The filtering membrane 18 is held in place on the seat 15 by virtue of an openwork wall 16 designed to rest on the face of the membrane that is on the other side from the bearing surface of the cover 5. The openwork wall 16 is of a shape to match that of the filtering membrane 18 and of the seat 15 of the latter in the cover 5. When it is in place, the openwork wall 16 is received in the housing formed by the upper or outer face of the filtering membrane 18 and the internal surface of the cylindrical portion 13. FIG. 3 illustrates the openwork wall 16 in position on the cover 5. It is possible to see that the outer surface of the wall 16 is at least approximately level with the upper edge of the cylindrical portion 13.

The openwork wall 16 comprises a continuous annular portion at its outer perimeter so as to hold the corresponding perimeter of the filtering membrane 18 on its bearing surface. The wall 16 also comprises two crossbars so as to hold the central portion of the filtering membrane 18 notably on the studs 22.

The openwork wall 16 is connected to one of the hooks, in this instance the hook 12 via a strip of flexible material 20. In a non-limiting manner, the latter is preferably made of the same material as the openwork wall 16 and the cover 5, including the hooks 12 and 14. The cover 5 may be made of injection-molded plastic material, in a manner well known per se to those skilled in the art.

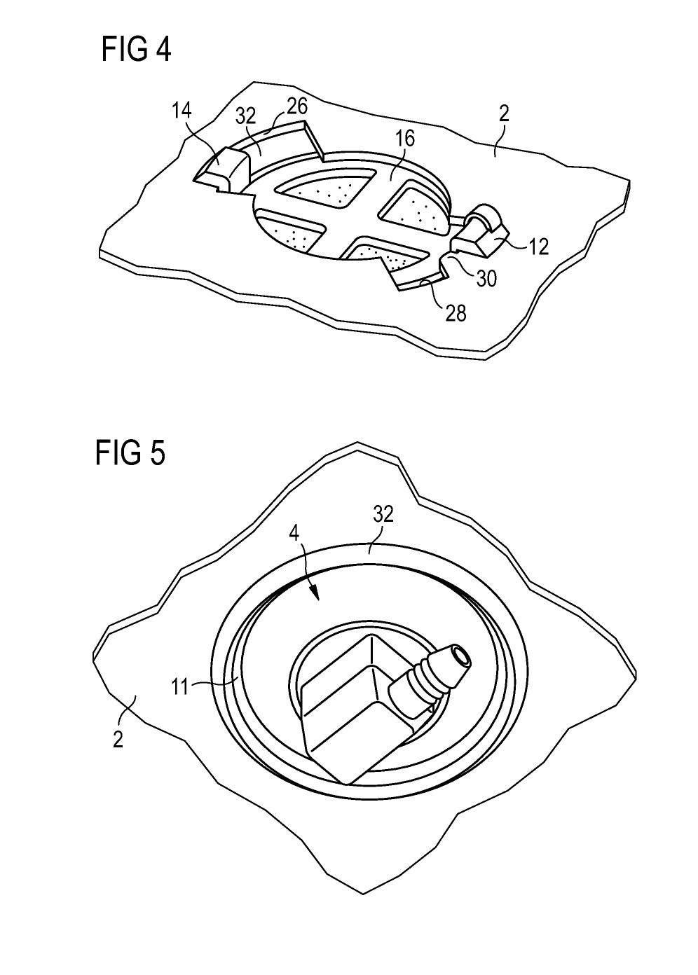

FIG. 4 illustrates the internal face of the wall 2 receiving the ventilating element 4. It is possible to see that the wall 2 comprises a generally circular opening of which the diameter is greater than or equal to that of the circle surrounding the holes that are present in the wall 16. The opening also comprises two extensions that are diametrically opposed and form sectors of larger diameter. The circular edges 26 and 28 of these two extensions have a variation in diameter so as to allow on the one hand each of the hooks 12 and 14 to penetrate the corresponding sector and, on the other hand, each of the hooks 12 and 14 to engage with the edge of the corresponding sector by rotation of the ventilating element 4. The circular edge 28 comprises a boss 30 on its portion of smaller diameter, close to the boundary between the two portions of different diameters. This boss 30 is designed to interact with the face of the hook 12 opposite to the edge in question when the ventilating element is put in place. More particularly, when the latter is rotated, the hook 12 will move along the edge of smaller diameter while deforming slightly in contact with the boss 30. The boss 30 is positioned so that the hook 12 is no longer pressing on the boss 30 in the position of attachment on the wall 2 so that the boss 30 constitutes an obstacle requiring the application of a force to move the hook 12 in rotation on the boss 30 for the purpose of removal of the ventilating element 4. It should be noted that this boss 30 may also be provided on the corresponding edge 26 of the other sector.

FIG. 5 illustrates the wall of FIG. 4 seen from outside the casing. It is possible to see that the wall 2 comprises a collar 32 protruding from the wall 2 in the manner of a cylindrical wall emanating from the surface of the wall 2. This collar 32 interacts with the surface 11 for mounting the cover 5 of the ventilating element 4, more particularly with the rounded portion of this surface so as to centre the ventilating element 4 and seal it with the wall 2. The internal surface of the collar 32 of the wall 2 is moreover visible in FIG. 4 at the sector 26 of the opening of the wall 2.

It should be noted that the embodiment that has just been described is purely exemplary and non-limiting. Many variations are possible.

For example, the number of hooks may vary from that of the embodiment described above. Specifically, the hooks may be three in number or even more. Moreover, the shape of the hooks and their method of coupling with the wall may vary.

The method of positioning the ventilating element in the plane of the wall and its sealing may vary from the embodiment described above notably with respect to the collar.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A ventilating element of a casing, notably to a casing of a lighting and/or signaling device of a vehicle, wherein said ventilating element comprises:
a cover defining an internal volume with an entrance and an exit arranged to allow the circulation of the air from the entrance to the exit or vice versa;
reversible means for attaching said cover to a wall of the said casing;
said cover comprising a seat for receiving a filter.

2. The ventilating element according to claim 1, wherein said cover produces a closed passage between said entrance and said exit, notably a duct between said entrance and said exit.

3. The ventilating element according to claim 1, wherein said cover comprises said filter, the latter being placed so that the air passes through said filter when it travels said entrance to said exit or vice versa.

4. The ventilating element according to claim 1, wherein said seat of said filter is situated at said exit of said internal volume.

5. The ventilating element according to claim 4, wherein said filter comprises a filtering membrane and said seat forms a shoulder designed to receive an edge of said filtering membrane.

6. The ventilating element according to claim 5, wherein said cover comprises at least one bearing zone for a central portion of said filtering membrane.

7. The ventilating element according to claim 1, wherein said cover comprises a surface for mounting said cover on said wall, said surface encircling said seat of said filter.

8. The ventilating element according to claim 7, wherein said surface for mounting said cover on said wall and/or said seat of said filter are circular.

9. The ventilating element according to claim 1, wherein said cover comprises at least two hooks capable of engaging with said wall by a rotary movement of said cover.

10. The ventilating element according to claim 1, wherein said ventilating element comprises removable means for keeping said filter on said seat of said cover.

11. The ventilating element according to claim 1, wherein said cover comprises an end-piece at said entrance of said internal volume designed to receive an air duct.

12. A casing wall, notably of a lighting and/or signaling device of a vehicle, wherein said casing wail is provided with a ventilating element according to claim 1.

13. The casing wall according to claim 12, wherein said ventilating element is a ventilating element comprises a surface for mounting said cover on said wall and/or said seat of said filter are circular and in that said wall comprises at least one opening with at least two edges.

14. The casing wall according to claim 13, wherein said ventilating element comprises at least two hooks capable of engaging with said wall by a rotary movement of said cover, each of the edges of said wall having a variation in diameter so as to allow the insertion of said at least two hooks of said cover and their coupling with the edges by rotation of said cover.

15. A casing of a lighting and/or a signaling device of a vehicle, wherein said casing comprises a ventilating element according to claim 1 and/or a wall.

16. A lighting and/or signaling device of a vehicle, wherein said lighting and/or signaling device comprises a casing according to claim 15.

17. The ventilating element according to claim 2, wherein said cover comprises said filter, the latter being placed so that the air passes through said filter when it travels from said entrance to said exit or vice versa.

18. The ventilating element according to claim 2, wherein said seat of said filter is situated at said exit of said internal volume.

19. A casing of a lighting and/or a signaling device of a vehicle, wherein said casing comprises a ventilating element and/or a wall according to claim 12.

20. A ventilating element of a casing, notably to a casing of a lighting and/or signaling device of a vehicle, wherein said ventilating element comprises:
a cover defining an internal volume with an entrance and an exit arranged to allow the circulation of the air from the entrance to the exit or vice versa;
at least one mount for attaching said cover to a wall of said casing;
said cover comprising a seat for receiving a filter.

21. The ventilating element according to claim 20, wherein said cover produces a closed passage between said entrance and said exit, notably a duct between said entrance and said exit.

22. The ventilating element according to claim 20, wherein said cover comprises said filter, the latter being placed so that the air passes through said filter when it travels from said entrance to said exit or vice versa.

23. The ventilating element according to claim 20, wherein said seat of said filter is situated at said exit of said internal volume.

24. The ventilating element according to claim 23, wherein said filter comprises a filtering membrane and said seat forms a shoulder designed to receive an edge of said filtering membrane.

25. The ventilating element according to claim 24, wherein said cover comprises at least one bearing zone for a central portion of said filtering membrane.

26. The ventilating element according to claim 20, wherein said at least one mount comprises a plurality of hooks.

27. The ventilating element according to claim 1, wherein said reversible means comprises a plurality of hooks.
